(19) United States
(12) Patent Application Publication
(10) Pub. No.: US 2013/0283614 A1
(43) Pub. Date: Oct. 31, 2013

(54) Connecting Rod Having a Press Fit and Method of Producing a Connecting Rod

(71) Applicant: Neumayer Tekfor Holding GmbH, Hausach (DE)

(72) Inventors: Mauro Moraes DE SOUZA, Jundiai - SP (BR); Juliano SAVOY, Jundiai - SP (BR); Matthias BECHTOLD, Haslach (DE)

(21) Appl. No.: 13/930,421

(22) Filed: Jun. 28, 2013

Related U.S. Application Data
(62) Division of application No. 13/278,684, filed on Oct. 21, 2011.
Application No. 13/278,684 is a continuation of application No. PCT/DE2010/000405, filed on Apr. 8, 2010.

(30) Foreign Application Priority Data
Apr. 24, 2009 (DE) 10 2009 018 827.4

(51) Int. Cl. F16C 7/02

(52) U.S. Cl. CPC F16C 7/02
USPC 29/888.09

(57) ABSTRACT

A connecting rod constructed as an assembly of a plurality of parts comprising a shaft, a big end eye and a small end eye connected to one another by at least one interference fit, preferably a cylindrical interference fit, and a method of producing a connecting rod from a plurality of such parts connected to one another by at least one interference fit.

### CROSS REFERENCE TO RELATED APPLICATIONS

This application is a divisional of U.S. application Ser. No. 13/278,684 filed Oct. 21, 2011 which is a continuation of international patent application no. PCT/DE2010/000405, filed Apr. 8, 2010 designating the United States of America and published in German on Oct. 28, 2010 as WO 2010/121587 A1, the entire disclosure of which is incorporated herein by reference. Priority is claimed based on Federal Republic of Germany patent application no. DE 10 2009 018 827.4, filed Apr. 24, 2009, the entire disclosure of which is likewise incorporated herein by reference.

### BACKGROUND OF THE INVENTION

The invention relates to a connecting rod comprising a shaft, a big end eye and a small end eye, in which the connecting rod is configured as a plurality of parts. The invention also relates to a method for production of a connecting rod, in which the connecting rod comprises at least one shaft, a big end eye and a small end eye.

A connecting rod—also referred to as a piston rod, con rod or driving rod—usually serves to convert the linear motion of the main, or working, pistons of an engine into the circular motion of the crankshaft. A connecting rod usually consists of a shaft, a big end eye and a small end eye. Big end eyes according to the prior art are usually divided and the initially one-part eye is parted by breaking (“cracking”) and usually connected again by two screws.

Methods for producing connecting rods include forging or sintering. German patent publication no. DE 10 2007 051 248 A1 discloses a connecting rod having a shaft which comprises two sheet metal profiles. German patent publication no. DE 35 16 506 A1 discloses a connecting rod in which the big end eye is connected to the connecting rod shaft via a screw connection. U.S. Pat. No. 7,111,604 (=DE 10 2006 037 871) discloses a complex construction of a connecting rod in which the two eyes are attached to a solid or hollow middle rod. U.S. Pat. No. 4,369,742 discloses a connecting rod in which two connecting rod halves are connected to one another by inserts. A constructed connecting rod is disclosed in German patent publication no. DE 100 18 064 A1, in which connecting possibilities are considered only generally. JP 63-199916 A discloses a constructed connecting rod in which the shaft is partially arranged in the two eyes. However, this document does not describe the means of connection. A multi-part connecting rod which is held together with a tensioning belt is disclosed in German patent publication no. DE 103 25 190 A1.

Problems in the prior art lie partly therein that production of the connecting rods is complex and/or costly. The connecting rods are also usually heavy.

### SUMMARY OF THE INVENTION

It is an object of the invention to provide an improved connecting rod. Another object of the invention is to provide a method of producing an improved connecting rod which overcomes the disadvantages of the prior art.

These and other objects are achieved in accordance with the present invention by a connecting rod in which at least one section of the shaft and one section of the big end eye are connected to one another by a, particularly cylindrical, interference fit, and/or that at least one section of the shaft and one section of the small end eye are connected to one another by a, particularly cylindrical, interference fit. The connecting rod is, therefore, specifically not constructed integrally, but is assembled from individual prefabricated parts. The connecting rod is therefore, particularly, an assembled connecting rod for use, particularly, in a vehicle with, for example, an internal combustion engine or hybrid engine. The interference fit or press fit serves to create the connection between the shaft and at least one of the eyes. If only one eye is fastened with a press fit, the other eye is fixed by an alternative method—e.g., shrink fitting or welding—or it is, for example, a component of the shaft. In particular, however, a cylindrical interference fit is involved, which is associated with the fact that the shaft is at least partially cylindrically formed.

In one embodiment of the connecting rod according to the invention, the shaft is essentially cylindrically formed. The shaft is, for example, configured essentially as a solid cylinder or as a hollow cylinder.

In another embodiment of the connecting rod according to the invention, the shaft has a chamfer at least at one of the two ends thereof.

In yet another embodiment of the connecting rod according to the invention, the big end eye has a recess for receiving a section of the shaft and/or the small end eye has a recess for receiving a section of the shaft. If the shaft is cylindrical, the recesses are preferably also essentially cylindrical. The configurations of the components to be connected to one another in the region of the mutual fixing are therefore preferably matched to one another. Depending on the different designs, the recess of the big end eye may be a blind bore and/or the recess of the small end eye may be a blind bore. Alternatively, respective through bores may be provided.

In still another embodiment of the connecting rod according to the invention, the recess of the big end eye has at least one undercut and/or the recess of the small end eye has at least one undercut. When the shaft is pressed in, the undercut serves to cause the shaft to become wedged into the undercut, so that an improved hold is produced.

In another embodiment of the connecting rod according to the invention, at least one protuberance is provided—in another embodiment, arranged essentially centrally—in the recess of the big end eye, and/or at least one protuberance is provided—in another embodiment, arranged essentially centrally—in the recess of the small end eye. The protuberance serves for guiding the shaft during the pressing-in procedure.

The protuberance has the effect, in particular, that the respective recess does not have a flat base and, in particular, also that the end region of the shaft is guided into the recess during pressing-in.

In another embodiment of the connecting rod according to the invention, the protuberance in the recess of the big end eye and the big end eye are integrally formed, and/or that the protuberance in the recess of the small end eye and the small end eye are integrally formed. Alternatively, the protuberance is a separate component. In this variant, therefore, the protuberance and the associated eye are, in particular, configured in two parts, and the protuberance is provided as an additional component separate from the associated eye.

In another embodiment of the connecting rod according to the invention, the shaft has at least one recess for receiving a section of the big end eye, and/or the shaft has at least one recess for receiving a section of the small end eye. In this embodiment, therefore, one of the two eyes is introduced into an end region of the shaft. In one variant thereof, one eye can be introduced into one end of the shaft, and the other end of the shaft is introduced into the other eye, i.e., other combinations are also possible. The recess in the shaft may also be produced directly by constructing the shaft in the form of a hollow cylinder. Alternatively, the recess in the shaft may be constructed as a blind bore.

In another embodiment of the connecting rod according to the invention, the big end eye and the small end eye are configured essentially the same size and/or have an essentially circular opening with the same diameter. In this embodiment, therefore, both eyes are configured essentially the same and are identified by different designations only for the sake of intelligibility in this description.

In another embodiment of the connecting rod according to the invention, the big end eye and the shaft are made from different materials and/or the small end eye and the shaft are made from different materials. In one embodiment, the big end eye and the small end eye are essentially made from the same material. In a further embodiment, at least one eye and the shaft are made from the same material. The multi-part construction of the connecting rod allows different materials to be combined, in order to take account of different requirements. If, for example, one eye is to be cracked, a special material can be used for this eye and a different material used for the shaft and/or the other eye.

In another embodiment of the connecting rod according to the invention, at least one securing ring is provided. The securing ring is configured and matched to the shaft and the small end eye or to the shaft and the big end eye such that the securing ring essentially prevents axial movement between the shaft and the small end eye or between the shaft and the big end eye. In one embodiment, the shaft and/or the small or big end eye have an essentially radial recess or groove into which the securing ring is introduced and such that the securing ring prevents or hinders axial movement between the shaft and the respective eye. In one embodiment, the securing ring may be a Seeger ring.

With regard to the production or manufacturing process, the objects of the invention are achieved by a process in which at least one section of the shaft is introduced into a section of the big end eye or in which at least one section of the big end eye is introduced into a section of the shaft, and/or in which at least one section of the shaft is introduced into a section of the small end eye, or in which at least one section of the small end eye is introduced into a section of the shaft, and a force which ensures a press fit is applied. The press fit is preferably created in the region in which two components (shaft, big end eye and small end eye) come into contact with one another, which results particularly from the partial introduction of the components into one another. The force is applied, for example, by pressing the shaft into a recess of an eye or by pressing part of an eye into a recess of the shaft.

In one embodiment of the method according to the invention, at least the shaft and/or the big end eye and/or the small end eye is at least partially and/or temporarily heated. Preferably, the heating takes place before the introduction of one component into another component and thus also before the step of applying the force which generates the press fit.

In another embodiment a securing ring is introduced into a groove which is preferably configured radially encircling the shaft or one of the eyes. When the shaft is partially introduced into a recess of the eye or the eye is partially introduced into a recess of the shaft, the securing ring relaxes and penetrates, for example, into a groove of the other component. Alternatively, the securing ring cuts or locks into the surface of the respective introduced component.

### BRIEF DESCRIPTION OF THE DRAWINGS

The invention will be described in greater detail hereinafter with reference to illustrative embodiments depicted in the accompanying drawings, in which:

FIG. 1 is a three-dimensional view of a connecting rod according to the invention;

FIG. 2 is a sectional view through the connecting rod of FIG. 1;

FIG. 3 is an enlarged portion of a section through a connecting rod according to the invention during manufacture;

FIG. 4 is a portion of a second variant of a connecting rod according to the invention, and

FIG. 5 is a sectional view through a further embodiment of a connecting rod according to the invention.

### DETAILED DESCRIPTION OF PREFERRED EMBODIMENTS

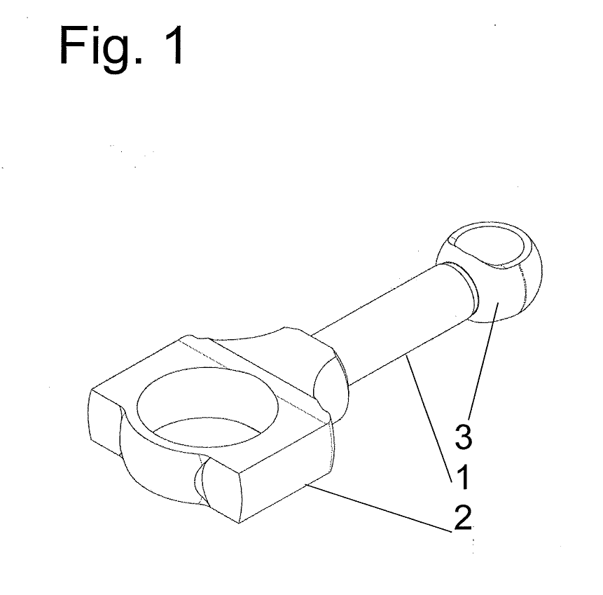

FIG. 1 shows a multi-part connecting rod according to the invention. This is, in particular, a three-part connecting rod, i.e. the shaft 1, the small end eye 3 and the big end eye 2 are each separate components that are joined together into the connecting rod. The shaft 1 in this example is cylindrically constructed, and can be a hollow cylinder or a solid cylinder or a partly hollow or filled-in cylinder. The two eyes 2, 3 each have the circular opening required for their function and are formed in the regions facing the shaft 1 so that they can be connected to the shaft 1. In the illustrated embodiment at the flanks of the big end eye 2, the regions are shown where the screws will be introduced to join the parted big end eye 2 together again. However, this configuration can also be dispensed with, depending on use or requirements.

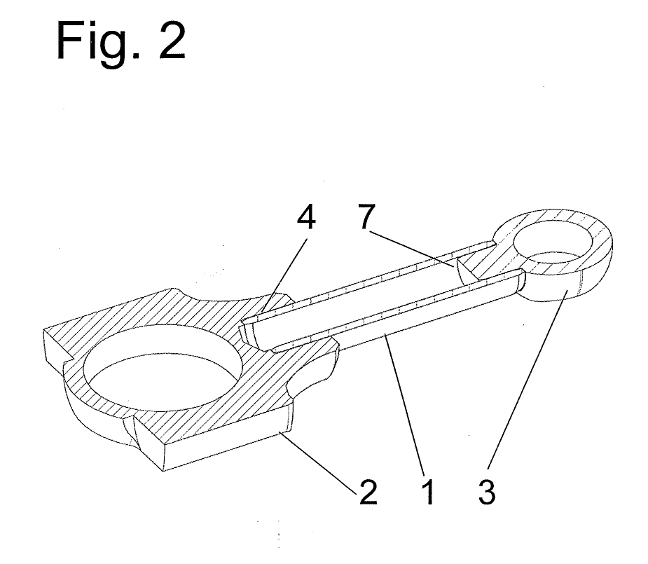

FIG. 2 shows that the shaft 1 is arranged with one end in a recess 4 of the big end eye 2 and with the recess 7 of the shaft on the other end surrounding a portion of the small end eye 3. Pressing the shaft 1 into the recess 4 causes a widening to form at the end of the shaft 1 which, in conjunction with the undercut in the recess 4, counteracts any tensional force tending to pull the rod out of the eye 2. Furthermore, the eyes 2, 3 and the shaft 1 are connected to one another in the respective contact regions by an interference fit or press fit.

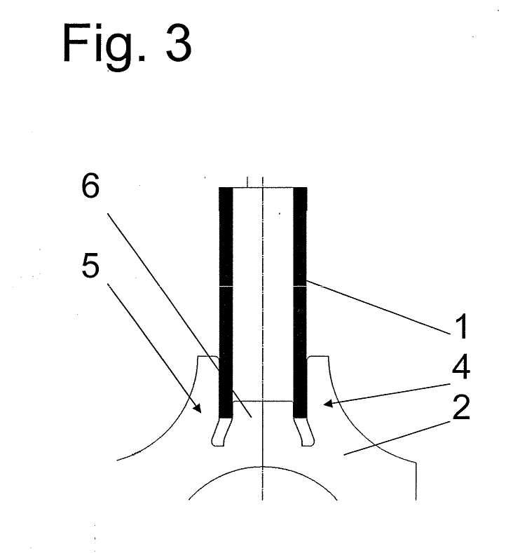

FIG. 3 shows a section through a connecting rod during production, in particular during the application of force in order to create the press fit. The shaft 1, which is configured here as a hollow cylinder, is pressed with one end, which preferably has a chamfer to facilitate introduction, into the recess 4 of the big end eye 2. An undercut 5 and a protuberance 6 are provided in the recess 4. In the embodiment shown here, the protuberance 6 and the big end eye 2 are constructed integrally, for example the protuberance 6 is suitably machined from the solid material of the big end eye 2. In an alternative variant, the protuberance 6 is an additional component which is introduced into the recess 4 configured as a blind bore in the big end eye 2 or which is inserted before the introduction of the shaft into the opening in the end region of the shaft. Due to the sides of the protuberance 6 broadening downwardly and the suitable configuration of the undercut 5, the wall of the hollow cylindrical-shaped shaft 1 is widened during the pressing-in process and is pressed into the—in this case, radially symmetrical—gap between the protuberance 6 and the inner wall of the recess 4. Moreover, a press fit is created between the outer wall of the shaft 1 and the inner wall of the recess 5 by the pressing-in, thus holding the individual parts of the connecting rod together. In another embodiment, the end of the shaft 1 is heated during production in order to facilitate the deformation during pressing, so that less pressure can be used.

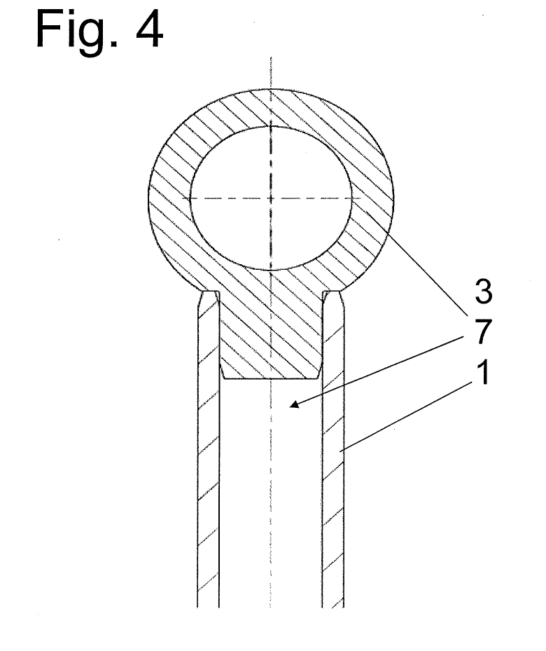

FIG. 4 shows a further variant in which the shaft 1 is pressed over an end region of the small end eye 3 and is held in place there by an interference fit. In the variant shown here, the shaft 1 is a hollow cylinder with a recess 7 for introducing a section of the small eye 3.

The variants of FIGS. 3 and 4 can also relate to the other eye, in which both eyes can also be fastened with the same variant. In a further variant, one eye or the associated end of the shaft is heated and the connection is made either by shrinking the eye onto the shaft or the shaft onto an end region of the eye.

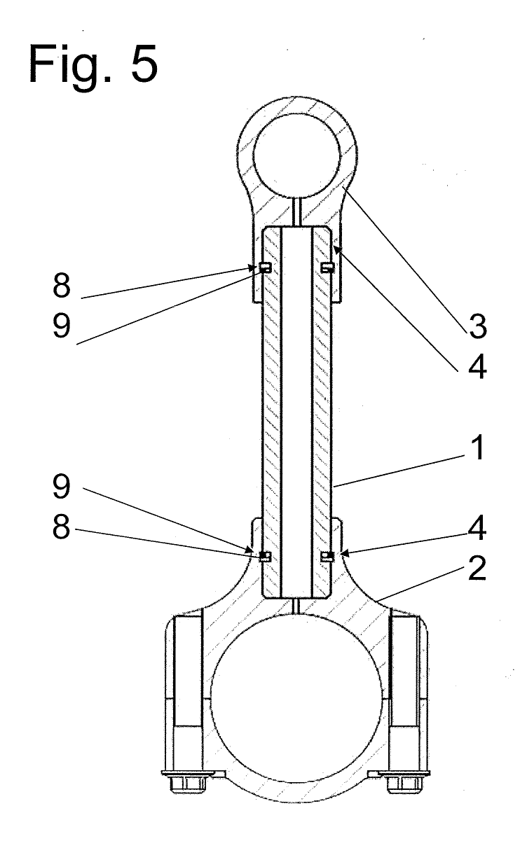

FIG. 5 shows a connecting rod in which two securing rings 9 are provided for axially securing the individual parts 1, 2 and 3 of the assembled connecting rod. These securing rings 9 are each introduced into grooves 8 of the two eyes 2, 3 and of the shaft 1. In this embodiment, the shaft 1 is inserted into the respective recesses 4 of the big end eye 2 and of the small end eye 3. Also shown is that the big end eye 2 comprises two individual parts which are connected together by screws, for example two screws.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for producing a connecting rod comprising a shaft, a big end eye and a small end eye, said method comprising:
introducing
at least one section of the shaft into a section of the big end eye, or
at least one section of the big end eye into a section of the shaft, or
at least one section of the shaft into a section of the small end eye, or
at least one section of the small end eye into a section of the shaft; and
applying a force which ensures an interference fit between the introduced section and the section into which it is introduced.

2. A method as claimed in claim 1, wherein said interference fit is a cylindrical interference fit.
